(19) United States
(12) Patent Application Publication
(10) Pub. No.: US 2006/0286964 A1
(43) Pub. Date: Dec. 21, 2006

(54) Communication method

(75) Inventors: Rafal Polanski, Warsaw (PL); Adel Hattab, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation, Espoo (FI)

(21) Appl. No.: 11/230,532

(22) Filed: Sep. 21, 2005

(30) Foreign Application Priority Data
Jun. 21, 2005 (GB) 0512647.9

(51) Int. Cl. H04M 11/00

(52) U.S. Cl. 455/406

(57) ABSTRACT

A method and controller in a communication system for determining a usage value of the communication system in a predefined area. At least one charging parameter is set for the predefined area based on the determined usage value. The controller includes a monitoring means for determining a usage value of the communication system in a predefined area and a charge controller means for setting at least one charging parameter for the predefined area based on the determined usage value.

The present invention relates to a method and apparatus for use in a communication system. In particular, the invention relates to setting a charging parameter in the communication system.

Communication networks typically operate in accordance with a given standard or specification which sets out what the various elements of the network are permitted to do and how that should be achieved. For example, the standard may define whether the user or more precisely, user equipment is provided with a circuit switched service or a packet switched service. The standard may also define the communication protocols which shall be used for the connection. The given standard also defines one or more of the required connection parameters. The connection parameters may relate to various features of the connection. The parameters may define features such as the maximum number of traffic channels, quality of service and so on or features that relate to multislot transmission.

In other words, the standard defines the “rules” and parameters on which the communication within the communication system can be based on. Examples of the different standards and/or specifications include, without limiting to these, specifications such as GSM (Global System for Mobile communications) or various GSM based systems (such as GPRS: General Packet Radio Service), AMPS (American Mobile Phone System), DAMPS (Digital AMPS), WCDMA (Wideband Code Division Multiple Access) or CDMA in UMTS (Code Division Multiple Access in Universal Mobile Telecommunications System) and so on.

The user equipment i.e. a terminal that is to be used for communication over a particular communication network has to be implemented in accordance with the predefined “rules” of the network. A terminal may also be arranged to be compatible with more than one standard or specification, i.e. the terminal may communicate in accordance with several different types of communication services. These user equipment are often called as multi-mode terminals, the basic example thereof being a dual-mode mobile station.

A communication system may provide a subscriber with a fixed line connection or a wireless connection for communication, such as for voice or data communication. An example of the fixed line systems is the public switched telephone network (PSTN). An example of a wireless communication system is the public land mobile network (PLMN) and another example is a satellite based mobile communication system. The wireless communication occurs typically via a radio frequency connection between the station of the subscriber and at least one network element of the communications system. Communication within the network is typically, but not necessarily, handled by fixed line connections between the various network elements. Communication may also be transmitted in a system comprising one or more data networks. An example of this is the voice over IP (Internet Protocol) arrangement enabling voice call over a packet switched data network. The communication system may also employ a combination of wireless, fixed line and/or data network communication for a connection between two terminals. The term “connection” is intended to refer to all types of communication between two signalling points, such as a user terminal. The communication via the connection may be, for example, in the form of a voice call or a multimedia call or a data communication session.

A communication network is a cellular radio network consisting of access entities typically referred to as cells. In most cases the cell can be defined as a certain area covered by one or several base transceiver stations (BTS) serving user equipment (UE), such as mobile stations (MS), via a radio interface and possibly connected to a base station subsystem (BSS). Several cells cover a larger area, and form typically a radio coverage area referred to as a location area (LA) or in some standards as a routing area (RA). It should be appreciated that the size of the location area or routing area depends on the system and circumstances, and may equal to one cell or be even smaller, such a part of a coverage area of a base station. A feature of the cellular system is that it provides mobility for the mobile stations, i.e. the mobile stations are enabled to move from a location area to another, and even from a network to another network that is compatible with the standard the mobile station is adapted to.

The user equipment (UE) within one of the cells of the cellular system can be controlled by a node providing controller function. Examples of the controller nodes include a base station controller (BSC), a radio network controller (RNC) and a mobile switching center (MSC), but other control nodes may also be implemented in the network. For example, in the circuit switched GSM (Global System for Mobile) network the controller node is provided by means of a mobile switching center (MSC). In the packet switched UMTS the radio access network thereof is controlled by a radio network controller (RNC). The controller can be connected further to a gateway or linking node, for example a gateway GPRS support node (GGSN) or gateway mobile switching center (GMSC), linking the controller nodes to other parts of the communication system and/or to other communication networks, such as to a PSTN (Public Switched Telecommunications Network) or to a data network, such as to a X.25 based network or to a TCP/IP (Transmission Control Protocol/Internet Protocol) based network. The network may also include nodes for storing information of mobile stations subscribing the networks or visiting the networks, such as appropriate home location registers (HLR) and visitor location registers (VLR).

When user equipment communicates with a communication network, a communication path has been established between the user equipment and an element or node of the network. The network node is typically one of the controller nodes. At least a part of the communication between the user equipment and the actual destination node will then pass through the controller node, or at least the controller node is aware of any such communication path.

In addition to basic voice and data services, the users of the subscriber terminals (such as fixed line telephones, data processing devices or PLMN mobile stations) may be provided with additional or advanced services. These can be defined as functions providing various sophisticated services or value-added services to the subscribers, for instance by means of software and/or hardware implementations provided in one or several nodes of the communication system. The additional services requested and subsequently invoked for a connection typically require control of at least one of the call management functions (e.g. routing, charging, duration, provision of connection or user related data and so on).

The additional services can be implemented by means of a functionality that is often referred to as intelligent network (IN). The term “intelligent network” was introduced by the BELLCORE organisation (USA) in the mid eighties. The intelligent network (IN) concept was developed in order to increase the flexibility and competitiveness of the telecommunication network architecture. Even though the initial IN architectures were developed to implement only certain specific services, for example service number, the current IN solutions provide the communication network operators with a possibility to implement new, powerful services in their networks in a fast and cost-effective manner.

The basic principles and operation of the IN applications are well known, and therefore they are not described herein in more detail. It is sufficient to note that in general the IN architecture comprises a (service) switching point (SSP) for triggering a call to the IN services and a (service) control point (SCP) for providing the service. The SSP and the SCP functions may be integrated in a service switching and control point (SSCP). A more detailed description of the general IN concept can be found e.g. from the recommendations by the International Telecommunications Union (ITU-T), such as IN Capability Set CS-1 published in 1993. The IN concept can be implement in the fixed land line networks, such as the public switched telephone network (PSTN), or the wireless radio communication networks, such as the public land mobile network (PLMN). Customised applications for mobile network enhanced logic (CAMEL) application part (CAP) protocol may be used in the SCP of a PLMN system for the provision of the service logic.

The user of a terminal, such as a mobile station, may be charged in various ways for using the services of the communication system. For instance, when a user makes calls, the charge for these calls may be calculated and stored in an account implemented by means of the intelligent network. The accrued charges in the account are then billed to the user at regular intervals. Alternatively, in a prepaid service arrangement the user of a terminal may purchase beforehand a certain predefined amount of calling time or other service time, which provides a balance in the user's account. The user may then make calls against his/her account until the balance runs out.

A call may be charged by debiting the account based on a calculated charge parameter that will referred to herein as a call charge. The call charge may be calculated based on a charging component. The call charge may be calculated by means of the intelligent network based on information that associates with the chargeable resource of the communication system. In some application the calculation is accomplished by means of a controller of the network, such as the mobile switching center or a specific billing centre. For example, in a GSM standard (Global System for Mobile communications) the call charge component may be calculated based on charging components that are referred to as e-parameters or main charging zone (MCZ) parameters. It should be noted that other standards may employ differently named parameters for the same purposes. The charging component for a call is typically obtained from a controller of the systems, such as from a mobile switching center (MSC) of the GSM system, for the calculation of the call charge, i.e. the calculation of the amount that is to be debited to the account.

A problem with communication systems is that the level of usage of the system is typically not equal at different locations. Thus in some geographical areas the demand for network resources may be much higher than in others. This problem can be addressed to a certain extent by providing more system resources covering areas of high demand. However usage of the communications system also fluctuates in a temporal manner, such that at certain times of day and on certain days the number of users may be many times greater than at other times.

This means that in order to provide sufficient resources covering every location able to cope with any possible surge in demand, a great deal of spare capacity needs to be provided. The total capacity of the system at a particular location may need to be much greater than the average demand, meaning that a large proportion of the total capacity is used only at times of peak demand. The presence of a large amount of unused spare capacity in the system is a source of inefficiency because costs are incurred in providing and maintaining resources which are underutilized.

However it is not easy to overcome this problem because even at times of generally high demand, localized factors may mean that in certain areas, there is still a large amount of spare capacity. Likewise at times of generally low demand, at certain locations there may be a surge of demand due, for example, to an event occurring within that area. Thus at any time in a communications system, there will be areas where the usage of the system is near to optimal with respect to the available resources, while in other areas usage is sub-optimal. The areas in which usage is optimal and sub-optimal may be constantly changing over time.

One approach to solving this problem is to set charging levels (tariffs) according to predicted times of peak demand, in order to encourage use at off-peak times and discourage it at peak times. Thus the tariff (for example the cost for a call of a particular duration) at an off-peak time may be lower than at a defined peak time. However, this approach does not take into account the localized differences in usage and is incapable of responding dynamically to unexpected demand surges within different areas.

Accordingly, the present invention provides a method in a communication system, comprising determining a usage value of the communication system in a predefined area, and setting at least one charging parameter for the predefined area based on the determined usage value.

In a further aspect, the present invention provides a communication system comprising a means for determining a usage value of the communication system in a predefined area, and a means for setting at least one charging parameter for the predefined area based on the determined usage value.

Embodiments of the present invention can improve the efficiency of resource management within a communication system, by allowing charging parameters to be set according to the demand for resources. In particular, by encouraging use of the system in areas and at times where demand is otherwise low. In this way, the average use of the system can be increased and spare capacity in the system is utilized rather than wasted. The invention allows charging to be adapted dynamically to the behaviour of users of the communication system. Conversely when users are informed of changes in charging parameters, the present invention can be used to influence the behaviour of users according to the charge level.

For a better understanding of the present invention, reference will now be made by way of example to the accompanying drawings, in which:

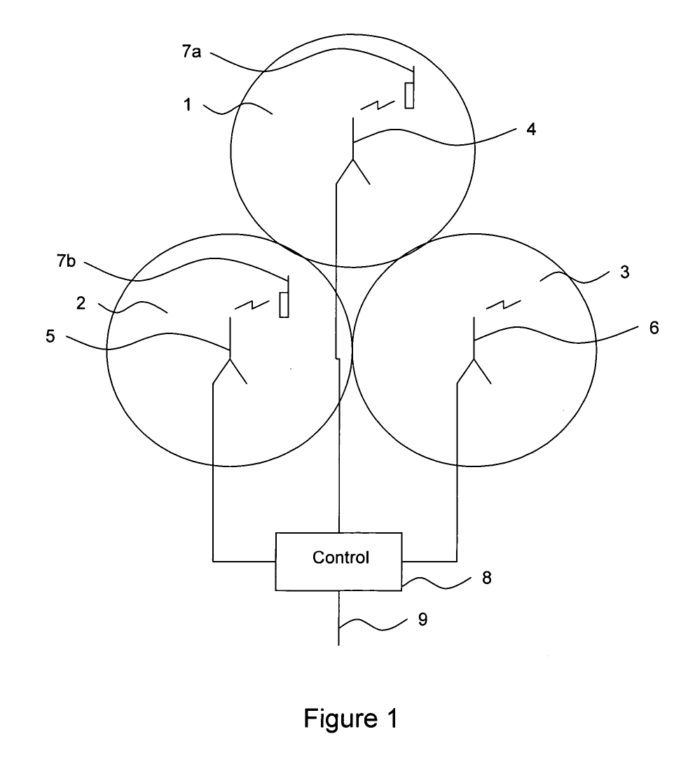

FIG. 1 shows a part of a communication system in which the present invention may be employed;

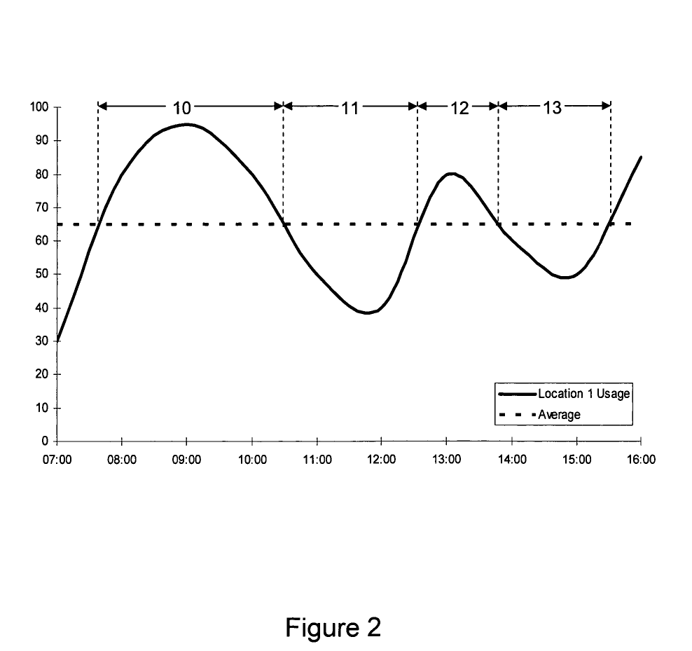

FIG. 2 shows the variation in network usage within a cell of a communication system over a period of time;

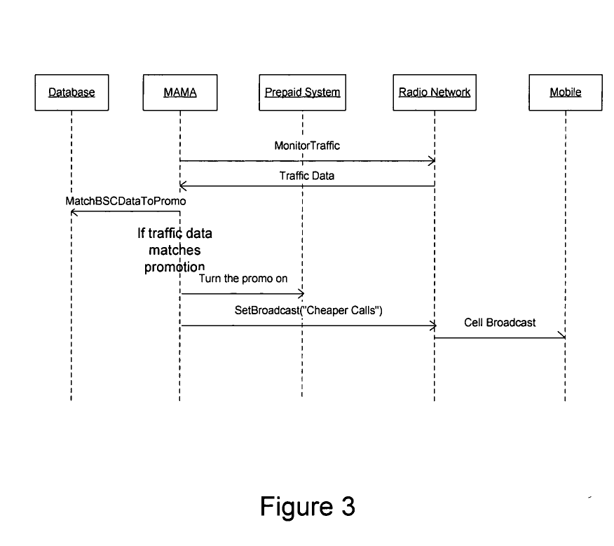

FIG. 3 shows a sequence diagram for implementing the present invention in a prepaid service.

FIG. 1 shows a simplified presentation of some of the components of a cellular system. More particularly, FIG. 1 shows an arrangement in which three radio coverage areas or cells 1, 2 and 3 of a cellular telecommunications network are provided.

More particularly, each of the radio coverage areas 1, 2 and 3 is provided by a respective base station 4, 5 and 6. Each base station 4 to 6 is arranged to transmit signals to and receive signals from mobile user equipment (UE) i.e. a plurality of mobile stations (MS) 7a and 7b via wireless communication. Likewise, the mobile stations 7a and 7b are able to transmit signals to and receive signals from the base stations. It shall be appreciated that a number of mobile stations may be in communication with each base.

It shall also be appreciated that that the presentation is highly schematic. The shape and size of the cells may be different from the illustrated substantially omnidirectional shape and uniform size. The size and shape of the cells may also vary from cell to cell. One cell may include more than one base station site. A base station apparatus or site may also provide more than one cell. These features of a cell depend on the implementation and circumstances.

Each of the base stations 4 to 6 is connected to a network controller function 8. The controller function may be provided by any appropriate controller. It shall also be appreciated that the name of the controller entity depends on the system. For example, a UMTS terrestrial radio access network (UTRAN) may employ a controller node that is referred to as a radio network controller (RNC). The GSM (Global System for Communications) based communication system employ mobile switching centre (MSC) for the provision of the control function.

It is also noted that typically more than one controller is provided in a cellular network. The controller function 8 may be connected to other appropriate elements, such as to another mobile switching centre (MSC) and/or a serving general packet radio service support node (SGSN), via a suitable interface arrangement 9. However, the various other possible controllers are omitted from FIG. 1 for clarity reasons.

FIG. 2 shows the variation in usage of the network within cell 1 over a period of time, along with the average usage in the cell. The usage value may be defined, for example, as the percentage of the available network resources used at a particular time. The usage varies over time such that in time intervals 111 and 13, i.e. between 10.30 am and 12.30 pm and between 1.45 pm and 3.45 pm, usage is suboptimal. In contrast, in time intervals 10 and 12, i.e. between 7.30 am and 10.30 am and between 12.30 pm and 1.45 pm, usage is considered to be near optimal in that it is above average.

According to one embodiment of the present invention shown in FIG. 3, a base station controller (BSC) linked to base station 4 monitors a usage value for the cell 1 at regular intervals, such as every 10 minutes. The BSC then provides the usage data to a charge controller located on an additional server element in the IP part of the network. The charge controller compares the usage data to a set of criteria contained in a promotion database. The promotion criteria define appropriate conditions of location, time or other factors under which a promotion may be launched, and set a defined usage value for these conditions. The charge controller determines whether the promotion criteria are met and whether defined usage value is greater than or less than the measured usage value for the cell 1.

If the promotion criteria are met and the measured usage value is less than the defined usage value, the charge controller launches a promotion, i.e. sets the tariff for call charges to users of the network within cell 1 at a reduced rate. At the same time, the charge controller directs base station 4 to send a message to each of the mobile stations 7a located in the cell 1, informing users in the cell that the tariff has been reduced. If the promotion criteria are not met or the measured usage value is greater than the defined usage value, the charge controller does not change the tariff but maintains it at the standard rate applying at the time.

If a promotion is indicated, the charge controller informs users that the tariff has been reduced for a set period of time, for example one hour. The charge controller may also inform users of the geographical area in which the reduced tariff applies, i.e. the area of cell 1. This information may be conveyed directly to users in the area by any suitable means, such as by short message service (SMS), multimedia message service (MMS), instant messaging (IM), broadcast or pushing to the mobile stations 7a of users in the area. The reduced tariff area may, for example, be described in words (e.g. via SMS), or a map showing the promotion area may be sent to the mobile station (e.g. via MMS).

Typically the reduced tariff stimulates increased demand for services, and usage of the system increases. During the reduced rate period which has been announced to users, the BSC may continue to report usage data, but the charge controller does not reset the tariff to the standard rate even if usage increases. Near the end of the reduced rate period, the charge controller sends a message to users in the promotion area, informing them that the reduced rate period will end soon, for example in 10 minutes time.

However towards the end of the promotion period, if the charge controller determines that the usage value is still sub-optimal, it may extend the reduced rate period and announce this extension to users. Alternatively, the charge controller may reset the tariff to the standard rate if usage has increased, or in some embodiments the charge controller may reset the tariff to the standard rate even if usage is still sub-optimal.

The conditions under which the promotion is to be extended or terminated can be set in the promotion database. Once the tariff is reset to the standard rate, the BSC continues to provide usage data to the charge controller, and the charge controller decides whether and when a further promotion is to be launched, for instance during a subsequent period of low usage.

A further BSC linked to base station 5 monitors a usage value for the cell 2, and provides the usage data to the charge controller. The usage value for cell 2 may vary independently of that for cell 1, and thus the usage profile of cell 2 may be significantly different to that shown in FIG. 2. The charge controller compares the usage data from cell 2 to the promotional criteria and defined usage value specific to that cell, and decides whether to launch a promotion in cell 2 according to those determinations.

Mobile station 7b is initially located in cell 2. Thus the user of mobile station 7b is informed, for example by SMS, of a reduced rate promotion in cell 2 lasting for a period of time in cell 2. However during the course of the reduced rate period, mobile station 7b may roam outside the promotion area, for example into cell 1 or cell 3 where no promotion is active at the time. The user of mobile station 7b is therefore informed when he leaves cell 2 that the reduced rate no longer applies. This information may be conveyed to the user, for example, by SMS during a handover procedure from cell 2 to cell 1 or cell 3. In a similar way, if mobile station 7a roams from cell 1, where no promotion is active, into cell 2, where a reduced rate promotion applies, a message is sent to mobile station 7a on entry to cell 2 informing the user of the promotion which is available in his new location.

The required data processing functions may be provided by means of one or more data processors. Appropriately adapted computer program code product may be used for implementing the embodiments, when loaded to a computer, for example a processor of the communication device and/or any of the other nodes associated with the operation. The program code mean may, for example, perform the generation of messages and/or information elements, interpretation and so forth. The program code product for providing the operation may be stored on and provided by means of a carrier medium such as a carrier disc, card or tape. A possibility is to download the program code product via a data network.

It is noted that whilst embodiments of the present invention have been described in relation to user equipment such as mobile stations, embodiments of the present invention are applicable to any other suitable type of user equipment.

It is also noted herein that while the above describes exemplifying embodiments of the invention, there are several variations and modifications which may be made to the disclosed solution without departing from the scope of the present invention as defined in the appended claims.

1. A method in a communication system, comprising:
determining a usage value of the communication system in a predefined area; and
setting at least one charging parameter for the predefined area based on the determined usage value.

2. A method according to claim 1, wherein the communication system comprises a mobile communications network providing wireless communication services for mobile stations.

3. A method according to claim 1, further comprising informing one or more users of the communication system of the set charging parameter.

4. A method according to claim 1, wherein the step of setting the charging parameter comprises comparing the determined usage value with a predefined usage value, and where the determined usage value is below the predefined usage value, setting the charging parameter at a reduced rate.

5. A method according to claim 4, wherein if the determined usage value is above the predefined usage value, the charging parameter is set at a standard rate greater than the reduced rate.

6. A method according to claim 4, wherein the charging parameter is set at the reduced rate for a defined period of time.

7. A method according to claim 1, wherein a predefined usage value is set at a predefined fraction of a capacity of the communication system.

8. A method according to any of claim 3, wherein the users are located within the predetermined area.

9. A method according to claim 1, wherein the usage value relates to a total communications traffic level in the communications system in the predefined area, as a fraction of a maximum total communications traffic level supportable by the communications system in the predefined area.

10. A method according to claim 1, wherein the usage value relates to a voice traffic level in the communications system in the predefined area, as a fraction of a maximum voice traffic level supportable by the communications system in the predefined area.

11. A method according to claim 10, wherein the charging parameter relates to a charge for voice calls in the communication system.

12. A method according to any of claim 1, wherein the usage value comprises a data traffic level in the communications system in the predefined area.

13. A method according to claim 12, wherein the charging parameter relates to a charge for data calls in the communication system.

14. A method according to claim 1, wherein the usage value comprises a messaging traffic level in the communications system in the predefined area.

15. A method according to claim 14, wherein the charging parameter relates to a charge for messaging in the communication system.

16. A method according to claim 1, wherein the predefined area comprises one or more access entities of the communication system.

17. A method according to claim 16, wherein the access entity comprises a cell, and a controller of the cell determines the usage value of the communication system within the cell.

18. A method according to claim 1, wherein the usage value is determined at a particular time, and the charging parameter is set for a time period subsequent to the particular time.

19. A method according to claim 1, wherein the usage value is monitored continuously or at repeated intervals, and the charging parameter is set following each determination of the usage value.

20. A method according to claim 1, further comprising comparing the usage value to one or more promotion criteria, and setting the charging parameter at a reduced rate if a promotion criterion is fulfilled.

21. A method according to claim 20, wherein the promotion criterion defines conditions of at least one of time and location according to which the charging parameter may be reduced.

22. A method according to any claim 1, further comprising charging a user of the communication system using the set charging parameter.

23. A method according to claim 1, wherein the charging parameter relates to a charge for a prepaid service.

24. A method according to claim 1, wherein the usage value is determined for each of a plurality of predefined areas in the communication system.

25. A method according to claim 24, wherein a charging parameter is set in each predefined area based on the determined usage value for that area.

26. A method according to claims 3, wherein the users are located within the predefined area.

27. A method according to claim 6, further comprising informing the users of the period of time for which the reduced rate is available.

28. A method according to claim 3, further comprising informing the users of the predefined area in which the reduced rate is available.

29. A method according to any of claim 3, further comprising informing the user that the set charging parameter applies when the user leaves the predetermined area.

30. A method according to any of claims 3, further comprising, informing the user that the set charging parameter no longer applies when the user leaves the predefined area.

31. A computer program embedded on a computer-readable medium comprising program code configured to perform the steps claim 1 when the program is run on a computer.

32. A controller for a communication system, the controller comprising:
a monitoring means for determining a usage value of the communication system in a predefined area; and
a charge controller means for setting at least one charging parameter for the predefined area based on the determined usage value.

33. A controller according to claim 32, further comprising means for informing one or more users of the communication system of the set charging parameter.

34. A controller according to claim 33, wherein the users are located within the predefined area.

35. A controller according to claim 33, further comprising means for informing the users of the period of time for which a reduced rate is available.

36. A controller according to claim 32, further comprising means for informing users of the predefined area in which a reduced rate is available.

37. A controller according to claims 32, wherein the charge controller is configured for compare the determined usage value with a predefined usage value, and where the determined usage value is below the predefined usage value, to set the charging parameter at a reduced rate.

38. A controller according to claim 37, wherein if the determined usage value is above the predefined usage value, the charging parameter is set at a standard rate greater than the reduced rate.

39. A communication system comprising:
a monitoring means for determining a usage value of the communication system in a predefined area; and
a charge controller means for setting at least one charging parameter for the predefined area based on the determined usage value.
